(19) United States
(12) Patent Application Publication
(10) Pub. No.: US 2023/0259093 A1
(43) Pub. Date: Aug. 17, 2023

(54) DRIVE SYSTEM

(71) Applicant: OMRON Corporation, Kyoto-shi (JP)

(72) Inventors: Megumu ASANO, Kyoto-shi (JP); Masakazu MATSUGAMI, Kyoto-shi (JP); Takao UEMURA, Kyoto-shi (JP); Ryuichi JIMBO, Kyoto-shi (JP)

(21) Appl. No.: 18/157,963

(22) Filed: Jan. 23, 2023

(30) Foreign Application Priority Data
Feb. 14, 2022 (JP) 2022-020661

(51) Int. Cl. G05B 19/05; H02K 11/30

(52) U.S. Cl. CPC G05B 19/054; G05B 19/058; H02K 11/30

(57) ABSTRACT

To provide a drive system provided with a plurality of control units configured to control electric motors, in which a wiring line is further simplified, the wiring line allowing a signal related to stopping of the electric motor to be input to the drive system. The drive system includes a plurality of control units each controlling a corresponding electric motor according to a command supplied from a host device via a first wiring line, a management unit including an input port that receives input of a first signal related to stopping of the electric motor, and a second wiring line that connects the management unit to the plurality of control units and is different from the first wiring line. The management unit distributes the first signal input to the input port to each of the plurality of control units via the second wiring line.

### CROSS-REFERENCE TO RELATED APPLICATION

This application is based on Japanese Patent Application No. 2022-020661 filed with the Japan Patent Office on Feb. 14, 2022, the entire contents of which are incorporated herein by reference.

### FIELD

The present invention relates to a drive system.

### BACKGROUND

In a drive system that drives a motor, the motor is generally controlled by a driver according to a command from a controller such as a programmable logic controller (PLC), or the motor is controlled based on preset information. In such a drive system, a servo driver that drives a plurality of shafts is also used (see, for example, JP 2005-086918 A and JP 2003-169497 A).

The servo driver is provided with a safety input port that receives, from a safety controller, an input of a signal related to stopping of the servo motor. In recent years, a so-called building block type servo system is also used, the system connecting a plurality of inverter units for controlling a servo motor to a converter unit for supplying a current. In the building block type servo system, because the safety input port is provided in each of the plurality of inverter units, a wiring line between the safety controller and each of the plurality of inverter units becomes complicated, which causes an increase in the workload and a risk of miswiring. Such a problem possibly occurs in common in a drive system including a servo system.

### SUMMARY

An object of one aspect of the disclosed technology is to simplify a wiring line that allows a signal related to stopping of an electric motor to be input to a drive system including a plurality of control units that control an electric motor.

One aspect of the disclosed technology is exemplified by the following drive system. The present drive system includes a plurality of control units each controlling a corresponding electric motor according to a command supplied from a host device via a first wiring line, a management unit including an input port that receives an input of a first signal related to stopping of the electric motor, and a second wiring line that connects the management unit to the plurality of control units and is different from the first wiring line. The management unit distributes the first signal input to the input port to each of the plurality of control units via the second wiring line.

In the drive system, when the first signal related to the stopping of the electric motor is input to the management unit, the first signal can be distributed from the management unit to the plurality of control units. That is, in the drive system, the first signal can be input to each of the control units without preparing a wiring line other than the second wiring line. Therefore, according to the present drive system, the wiring line can be further simplified, the wiring line allowing the first signal to be input to the drive system including the plurality of control units.

In the present drive system, the control unit may stop the electric motor when the first signal is no longer distributed from the management unit. Further, in the drive system, the control unit may stop the electric motor when the first signal is distributed from the management unit. Examples of the first signal related to the stopping of the electric motor include a safety signal and an ESTOP signal. The control unit stops the electric motor when the distribution of the safety signal is stopped. Further, the control unit stops the electric motor when the ESTOP signal is distributed. The present drive system having the above feature can stop the electric motor according to the safety signal or the ESTOP signal.

The present drive system may have the following feature. The control unit stops the electric motor corresponding to the own control unit in synchronization with the electric motor associated with another control unit. With such a feature, the present drive system can suitably stop the electric motor even in a system in which a plurality of shafts cooperatively operate, such as a gantry mechanism. Here, as a method of stopping the electric motor, any one of stopping by free run, stopping by deceleration torque, and stopping by driving a braking device may be used.

The present drive system may have the following feature. Each of the plurality of control units further includes a second input port that receives an input of a second signal related to stopping of the electric motor. Moreover, each of the plurality of control units selects one of the first signal distributed from the management unit and the second signal input to the second input port, and performs control related to the stopping of the electric motor. With such a feature, the present drive system can cause the management unit to input the first signal and the control unit to input the second signal, which increases a degree of freedom in constructing the present drive system.

The present drive system may have the following feature. Among the plurality of control units, a first control unit connected to the management unit through the second wiring line and arranged adjacent to the management unit further includes a detection circuit that is connected to the second input port and detects an abnormality of the second input port, and by connecting the input port of the management unit to the detection circuit of the first control unit through the second wiring line, abnormality of the input port is detected by the detection circuit. With such a feature, the present drive system can omit the detection circuit that detects the abnormality of the input port from the management unit, which can reduce the manufacturing cost of the management unit.

The disclosed technology can simplify a wiring line that causes a signal related to stopping of an electric motor to be input to a drive system including a plurality of control units that control the electric motor.

### BRIEF DESCRIPTION OF THE DRAWINGS

FIG. 1 is a diagram showing an example of a servo system according to an embodiment;

FIG. 2 is a diagram schematically showing connection between a converter unit and an inverter unit in the servo system according to the embodiment;

FIG. 3 is a diagram showing a first example of a schematic configuration for distributing a safety signal supplied from a safety controller in the embodiment;

FIG. 4 is a diagram showing a second example of a schematic configuration for distributing the safety signal supplied from the safety controller in the embodiment;

FIG. 5 is a diagram showing a third example of a schematic configuration for distributing the safety signal supplied from the safety controller in the embodiment;

FIG. 6 is a first diagram exemplifying connection between the safety controller and the control unit in the embodiment;

FIG. 7 is a second diagram exemplifying connection between the safety controller and the control unit in the embodiment;

FIG. 8 is a diagram showing an example of the servo system according to a first modification; and

FIG. 9 is a diagram showing an example of a self-diagnosis circuit of the servo system according to a second modification.

### DETAILED DESCRIPTION

### Embodiment

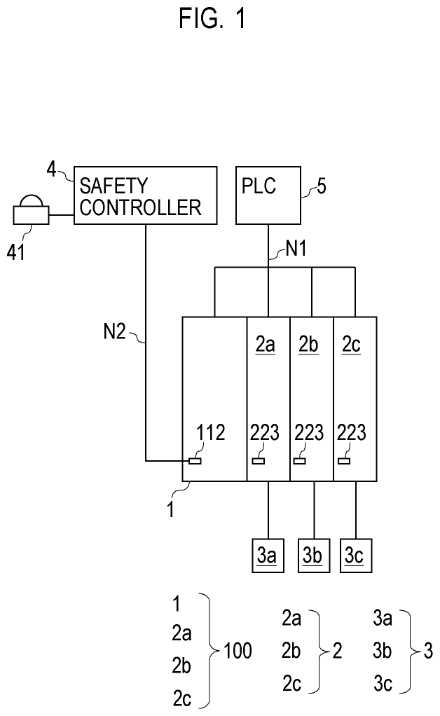

Hereinafter, a servo system according to an embodiment is described with reference to the drawings. FIG. 1 is a diagram showing an example of a servo system 100 according to the embodiment. The servo system 100 includes a converter unit 1, an inverter unit 2a, an inverter unit 2b, and an inverter unit 2c. The inverter unit 2a is connected to a servo motor 3a, the inverter unit 2b is connected to a servo motor 3b, and the inverter unit 2c is connected to a servo motor 3c. In a case where the inverter unit 2a, the inverter unit 2b, and the inverter unit 2c are not distinguished from one another, each of the three are also referred to as the inverter unit 2. Further, in a case where the servo motor 3a, the servo motor 3b, and the servo motor 3c are not distinguished from one another, each of the three are also referred to as the servo motor 3. The servo system 100 is connected to the PLC 5 through an industrial network N1. The converter unit 1 of the servo system 100 is connected to the safety controller 4. The safety controller 4 may be a part of the system of the PLC 5. The servo system 100 is an example of a “drive system”.

The safety controller 4 is connected to an input port 112 of the converter unit 1 through a safety signal line N2. The safety controller 4 continuously outputs a safety signal to the input port 112 of the converter unit 1 via the safety signal line N2. An emergency stop button 41 is connected to the safety controller 4. When the emergency stop button 41 is pressed, the safety controller 4 stops the output of the safety signal to the converter unit 1. The safety signal is an example of a “signal related to stopping of an electric motor”.

The PLC 5 outputs a command signal to the converter unit 1 and the inverter unit 2 of the servo system 100 via the industrial network N1. The PLC 5 functions as, for example, a monitoring device of the servo system 100 by executing processing according to a program prepared in advance. The industrial network N1 is, for example, a TCP/IP network. The industrial network N1 is an example of a “first wiring line”.

The servo system 100 is a building block type servo system including the converter unit 1 and the plurality of inverter units 2. In the servo system 100, the plurality of inverter units 2 can be connected to one converter unit 1, and the inverter unit 2 connected to the converter unit 1 can be disconnected from the converter unit 1. In FIG. 1, the servo system 100 includes three inverter units 2, but the number of inverter units 2 may be two or less or four or more. The servo system 100 is an example of a “servo system”.

The converter unit 1 and the inverter unit 2 receives the command signal from the PLC 5 via the industrial network N1. The converter unit 1 includes a safety port 112. The converter unit 1 receives an input of the safety signal from the safety controller 4 connected to the safety port 112. Further, the converter unit 1 supplies a current supplied from a not-illustrated power supply to the inverter unit 2. The safety signal input to the safety port 112 is an example of a “first signal”.

The converter unit 1 distributes the safety signal input from the safety controller 4 to the inverter units 2a, 2b, and 2c. When the emergency stop button 41 is pressed, because the input of the safety signal from the safety controller 4 to the converter unit 1 is stopped, the distribution of the safety signal from the converter unit 1 to the inverter units 2a, 2b, and 2c is also stopped. The converter unit 1 is an example of a “management unit”.

The inverter unit 2 receives power supply from the converter unit 1 and supplies a drive current to the servo motor 3. The inverter unit 2 receives a feedback signal from the servo motor 3. In each of the inverter units 2, a servo system that performs feedback control using a position controller, a speed controller, a current controller, and the like is formed, and the servo motor 3 is servo-controlled and driven using these signals. The inverter unit 2 is provided with a safety port 223 that receives the input of the safety signal from the safety controller 4. When the distribution of the safety signal from the converter unit 1 or the input of the safety signal from the safety port 223 is stopped, the inverter unit 2 stops the servo motor 3. The inverter unit 2 is an example of a “control unit”. The safety port 223 is an example of a “second input port”.

The servo motor 3 is, for example, an AC servomotor. The servo motor 3 operates by receiving a drive current supplied from the inverter unit 2. The servo motor 3 detects a displacement of an output shaft of the servo motor 3, and outputs a feedback signal indicating the detected displacement to the inverter unit 2. The servo motor 3 is an example of an “electric motor”.

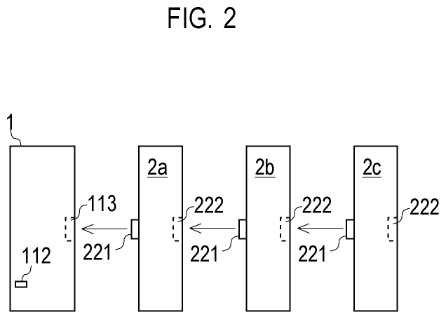

FIG. 2 is a diagram schematically showing connection between the converter unit 1 and the inverter unit 2 in the servo system 100 according to the embodiment. A female other-unit connection port 113 is provided on a side surface of the converter unit 1. A male upstream-side connection terminal 221 is provided on a side surface of the inverter unit 2 on the converter unit 1 side (upstream side). In addition, a female downstream-side connection port 222 is provided on a side surface of the inverter unit 2 on the side opposite to the converter unit 1 side (downstream side). The other-unit connection port 113 of the converter unit 1 is connected to the upstream-side connection terminal 221 of the inverter unit 2a, the downstream-side connection port 222 of the inverter unit 2a is connected to the upstream-side connection terminal 221 of the inverter unit 2b, and the downstream-side connection port 222 of the inverter unit 2b is connected to the upstream-side connection terminal 221 of the inverter unit 2c. In the servo system 100, by connecting the converter unit 1 and the inverter unit 2 in this manner, an internal signal line to be described later is connected. By having the internal signal line connected, current can be supplied from the converter unit 1 to the inverter unit 2 and the safety signal can be distributed.

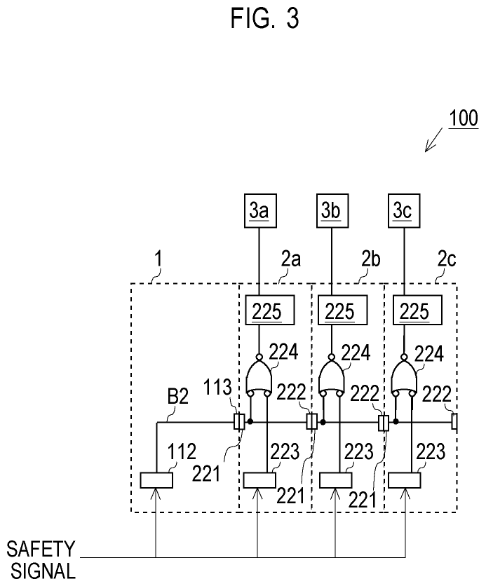

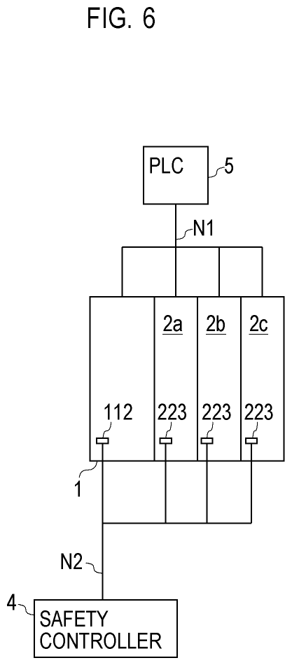

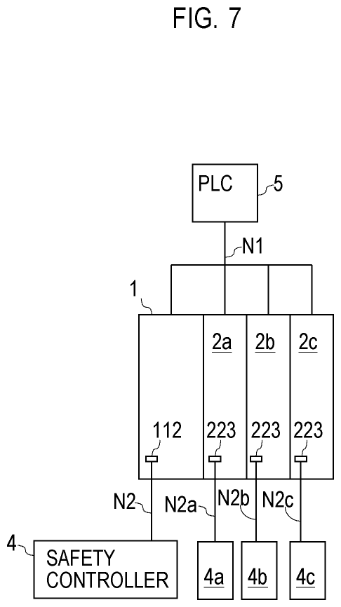

FIGS. 3 to 5 exemplify a schematic configuration for distributing the safety signal supplied from the safety controller 4 in the embodiment. Note that FIGS. 3 to 5 exemplify a case where the safety signal is also input to the safety port 223 of the inverter unit 2. As exemplified in FIG. 6, the safety signal input to the safety port 223 of the inverter unit 2 may be input from the safety controller 4 by connecting a wiring line from the safety signal line N2 to the safety port 223. Alternatively, the safety signal input to the safety port 223 of the inverter unit 2 may be input from a safety unit individually prepared for each of the inverter units 2 as exemplified in FIG. 7. That is, the safety port 223 of the inverter unit 2a may be connected to the safety controller 4a by the safety signal line N2a, the safety port 223 of the inverter unit 2b may be connected to the safety controller 4b by the safety signal line N2b, and the safety port 223 of the inverter unit 2c may be connected to the safety controller 4c by the safety signal line N2c. In addition, each of the inverter units 2 may receive the input of the safety signal from the safety controller 4 connected to the safety port 223 of the own unit. In the present description, hereinafter, the safety controllers 4, 4a, 4b, and 4c are described as the safety controllers 4 without distinguishing one another. The safety signal input to the safety port 223 is an example of a “second signal”.

FIG. 3 is a diagram showing a first example of a schematic configuration for distributing the safety signal supplied from the safety controller in the embodiment. The safety signal input to the safety port 112 of the converter unit 1 is distributed to the inverter units 2 via an internal signal line B2. The inverter unit 2 is provided with a NOR circuit 224 whose input is connected to the internal signal line B2 and the safety port 223. The output of the NOR circuit 224 is connected to a motor drive circuit 225 that drives the servo motor 3. When the safety signal is no longer input from either the safety port 112 or the safety port 223, the NOR circuit 224 outputs the emergency stop signal to the motor drive circuit 225. The motor drive circuit 225 to which the emergency stop signal is input stops the servo motor 3. The internal signal line B2 is an example of a “second wiring line”. The internal signal line B2 is not a single common signal line, but may have a configuration in which a circuit is interposed in the middle.

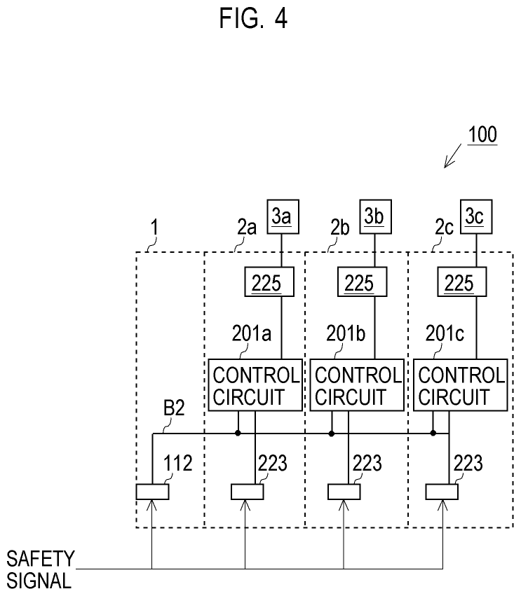

FIG. 4 is a diagram showing a second example of a schematic configuration for distributing the safety signal supplied from the safety controller in the embodiment. In FIG. 4, illustration of the other-unit connection port 113, the upstream-side connection terminal 221, and the downstream-side connection port 222 is omitted in order to prevent the drawing from being complicated. In FIG. 4, the inverter unit 2a includes a control circuit 201a instead of the NOR circuit 224. The inverter unit 2b includes a control circuit 201b instead of the NOR circuit 224. The inverter unit 2c includes a control circuit 201c instead of the NOR circuit 224. In a case where the control circuits 201a, 201b, and 201c are not distinguished from one another, each of the three are also referred to as the control circuit 201. The control circuit 201 includes a processor and a memory, and executes various types of processing according to a program stored in the storage. When the safety signal is no longer input from either the safety port 112 or the safety port 223, the control circuit 201 outputs the emergency stop signal to the motor drive circuit 225. The internal signal line B2 is an example of a “second wiring line”. The internal signal line B2 is not a single common signal line, but may have a configuration in which the signal line is separated by the control circuits 201a, 201b, and 201c.

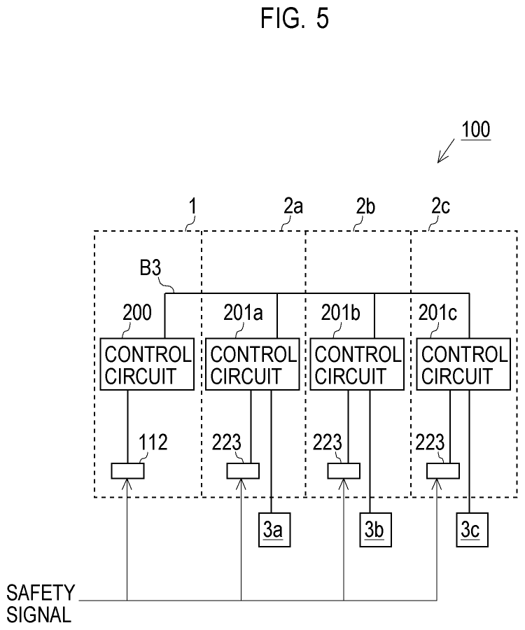

FIG. 5 is a diagram showing a third example of a schematic configuration for distributing the safety signal supplied from the safety controller in the embodiment. In FIG. 5, illustration of the other-unit connection port 113, the upstream-side connection terminal 221, and the downstream-side connection port 222 is omitted in order to prevent the drawing from being complicated. In the example in FIG. 5, the converter unit 1 includes a control circuit 200. Further, in the converter unit 1, the safety signal input via the safety port 112 is input to the control circuit 200. In the inverter unit 2, the safety signal input via the safety port 223 is input to the control circuit 201.

In the example in FIG. 5, the control circuit 200 of the converter unit 1 is connected to the control circuit 201 of the inverter unit 2, and the control circuits 201 of the inverter units 2 are connected to each other, through an inter-control circuit internal signal line B3. The safety signal input to the converter unit 1 via the safety port 112 is distributed to the control circuits 201 of the respective inverter units 2 via the inter-control circuit internal signal line B3. Each of the control circuits 201a, 201b, and 201c receives, from a user, designation as to which of the safety signal distributed from the converter unit 1 and the safety signal input from the safety port 223 is enabled. Each of control circuits 201a, 201b, and 201c performs the emergency stop of the servo motor 3 according to the safety signal designated by the user.

<Action and Effect of Embodiment>

In the present embodiment, the safety signal input to the safety port 112 of the converter unit 1 is distributed to the inverter units 2a, 2b, and 2c. Therefore, according to the present embodiment, even if the connection between each of the inverter units 2a, 2b, and 2c and the safety controller 4 through the safety signal line N2 is omitted, the servo motors 3a, 3b, and 3c respectively connected to the inverter units 2a, 2b, and 2c can be stopped emergently according to the safety signal from the safety controller 4. That is, according to the present embodiment, because the connection between the inverter units 2a, 2b, and 2c and the safety controller 4 through the safety signal line N2 can be omitted, the connection between the building block type servo system including the plurality of inverter units and the safety controller can be further simplified.

In the present embodiment, because the safety signal is distributed from the converter unit 1 to the inverter units 2a, 2b, and 2c via the internal signal line B2, the safety port 223 can be omitted from the inverter units 2a, 2b, and 2c. Therefore, according to the present embodiment, the configuration of the servo system 100 can be further simplified.

In the present embodiment, the safety port 223 may be provided in the inverter unit 2. By providing the safety port 223 in the inverter unit 2, the inverter unit 2 can directly receive the safety signal from the safety controller 4. By adopting such a configuration, the inverter unit 2 can receive the safety signal distributed from the converter unit 1, and can also receive the input of the safety signal from the safety port 223, which enables the degree of freedom in constructing the servo system 100 to increase. Note that, in a case where the safety port 223 is not provided in the inverter unit 2, the inverter unit 2 may not include the control circuit 201 and the NOR circuit 224.

<First Modification>

In the embodiment, the servo motor 3 is stopped emergently when the safety signal from the safety controller 4 is no longer input. However, the configuration for emergently stopping the servo motor 3 is not limited to such a configuration. In a first modification, a configuration in which the ESTOP signal is input to the converter unit 1 instead of the safety signal is described.

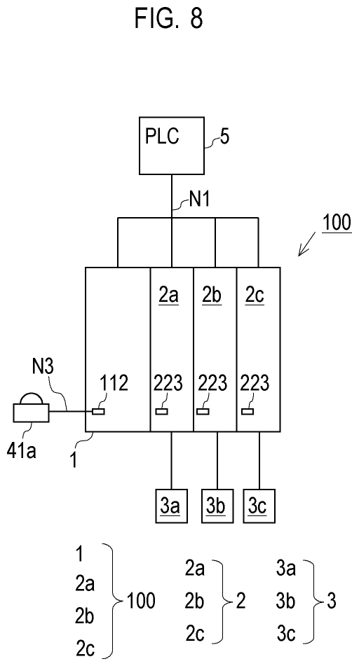

FIG. 8 is a diagram showing an example of the servo system 100 according to the first modification. In the first modification, instead of the safety controller 4, an emergency stop button 41a is connected to the safety port 112 of the converter unit 1 through an ESTOP signal line N3.

When being pressed, the emergency stop button 41a outputs an ESTOP signal for emergently stopping the servo motor 3. The ESTOP signal output from the emergency stop button 41a is input to the converter unit 1 via the safety port 112. The converter unit 1 distributes the ESTOP signal input via the safety port 112 to the inverter units 2 via the internal signal line B2. Upon receiving the ESTOP signal distributed from the converter unit 1, the inverter unit 2 stops the servo motor 3. The ESTOP signal is an example of a “signal related to stopping of an electric motor”.

Here, the servo motor 3 may be stopped, for example, by bringing the servo motor 3 into a free-run state in response to a command from the inverter unit 2. Alternatively, the servo motor 3 may be stopped, for example, by applying deceleration torque to the servo motor 3 in response to a deceleration command from the inverter unit 2. Alternatively, the servo motor 3 may be stopped, for example, by driving a braking device provided in the servo motor 3 in response to a command from the inverter unit 2. Here, each of the inverter units 2a, 2b, and 2c may stop the corresponding one of the servo motor 3a, the servo motor 3b, and the servo motor 3c in synchronization. By stopping the servo motors 3 in synchronization, the servo motor 3 can be suitably stopped even in a system in which a plurality of shafts cooperatively operate, such as a gantry mechanism.

<Second Modification>

In a case where the safety port 112 is provided in the converter unit 1 as in the embodiment described above, the self-diagnosis is preferably performed, the self-diagnosis detecting the abnormality of the safety port 112 provided in the converter unit 1. However, while the inverter unit 2 that controls the servo motor 3 includes a self-diagnosis circuit, the converter unit 1 that supplies power to the inverter unit 2 often does not include a self-diagnosis circuit. If the converter unit 1 also includes the self-diagnosis circuit, the configuration of the converter unit 1 becomes complicated, and the cost of the converter unit 1 also increases. Therefore, in a second modification, a modification in which the self-diagnosis of the safety port 112 can be performed while the self-diagnosis circuit of the converter unit 1 is omitted is described.

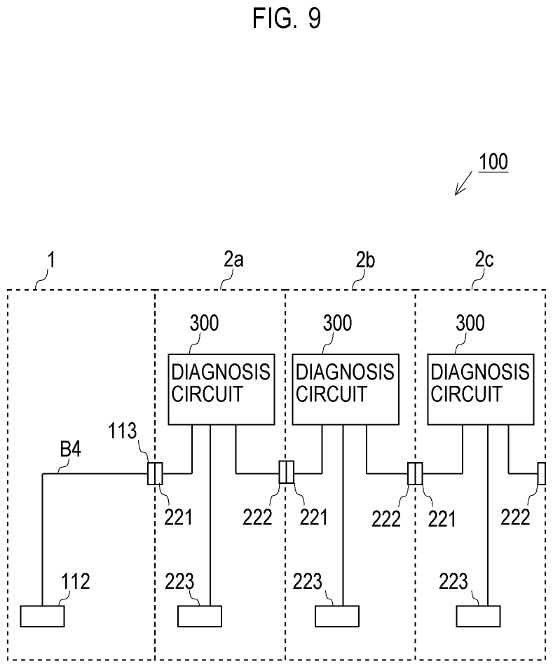

FIG. 9 is a diagram showing an example of a self-diagnosis circuit of the servo system 100 according to the second modification. In the second modification, the converter unit 1 is not provided with a diagnosis circuit that performs self-diagnosis of the safety port 112. The safety port 112 of the converter unit 1 is connected to the other-unit connection port 113 via a self-diagnosis internal signal line B4.

The inverter unit 2 includes a diagnosis circuit 300 that performs the self-diagnosis of the safety port 112 and the safety port 223. The diagnosis circuit 300 of the inverter unit 2 is connected with the upstream-side connection terminal 221 of the own unit, the safety port 223 of the own unit, and the downstream-side connection port 222 of the own unit. For example, the diagnosis circuit 300 of the inverter unit 2a is connected with the upstream-side connection terminal 221 of the inverter unit 2a, the safety port 223 of the inverter unit 2a, and the downstream-side connection port 222 of the inverter unit 2a. The diagnosis circuit 300 is an example of a “detection circuit”.

Further, the safety port 112 of the converter unit 1 is connected to the diagnosis circuit 300 of the inverter unit 2a arranged next to the converter unit 1 through the self-diagnosis internal signal line B4, the other-unit connection port 113, and the upstream-side connection terminal 221. The inverter unit 2a can perform the self-diagnosis of the safety port 112 of the converter unit 1 via the self-diagnosis internal signal line B4, the other-unit connection port 113, and the upstream-side connection terminal 221. Therefore, according to the second modification, the abnormality of the safety port 112 of the converter unit 1 can be detected without the converter unit 1 being provided with the diagnosis circuit 300. Note that the self-diagnosis of the safety port 223 of the inverter unit 2 may be performed by the diagnosis circuit 300 of the own unit.

Even when an abnormality is detected by the function mounted on the converter unit 1, the converter unit 1 may notify the inverter unit 2a of the abnormality via the self-diagnosis internal signal line B4.

In the embodiment described above, the servo system 100 includes the converter unit 1 as the management unit and the inverter unit 2 as the control unit, but the servo system 100 may include other configurations. The servo system 100 may include, for example, an input/output (I/O) or the like as an optional unit, the I/O having an output function other than the output to the motor, or may include a unit having a combined function of a converter unit, an inverter unit, and an optional unit. The management unit may also be an inverter unit, an optional unit, or a combined unit. Moreover, the control unit may also be an inverter unit, an optional unit, or a combined unit.

In the embodiment described above, the servo system 100 is a so-called servo system controlled by the PLC 5, but the application target of the technology according to the present embodiment is not limited to the servo system. The application target of the technology according to the present embodiment may be, for example, a drive system (control of a stepping motor or the like) that does not require control by feedback from an encoder, or may be a so-called inverter system that operates independently without requiring a command from a host.

The embodiments and modifications disclosed above can be combined with each other.

<Supplementary Note 1>

A servo system (100) including:

a plurality of control units (2) each configured to control a corresponding electric motor (3) according to a command supplied from a host device (5) via a first wiring line (N1);

a management unit (1) including an input port (112) configured to receive input of a first signal related to stopping of the electric motor; and

a second wiring line (B2) configured to connect the management unit (1) to the plurality of control units (2), the second wiring line being different from the first wiring line,

in which the management unit (1) is configured to distribute, via the second wiring line (B2), the first signal input to the input port (112) to each of the plurality of control units (2).

1. A drive system comprising:
a plurality of control units each configured to control a corresponding electric motor according to a command supplied from a host device via a first wiring line;
a management unit comprising an input port configured to receive input of a first signal related to stopping of the electric motor; and
a second wiring line configured to connect the management unit to the plurality of control units, the second wiring line being different from the first wiring line, wherein
the management unit is configured to distribute, via the second wiring line, the first signal input to the input port to each of the plurality of control units.

2. The drive system according to claim 1, wherein the control unit stops the electric motor when the first signal is no longer distributed from the management unit.

3. The drive system according to claim 1, wherein the control unit stops the electric motor when the first signal is distributed from the management unit.

4. The drive system according to claim 1, wherein the control unit stops an electric motor corresponding to an own control unit in synchronization with an electric motor associated with another control unit.

5. The drive system according to claim 1, wherein the control unit stops the electric motor by causing the electric motor to free-run.

6. The drive system according to claim 1, wherein the control unit stops the electric motor by applying deceleration torque to the electric motor.

7. The drive system according to claim 1, wherein the control unit stops the electric motor by driving a braking device included in the electric motor.

8. The drive system according to claim 1, wherein each of the plurality of control units further comprises a second input port configured to receive input of a second signal related to stopping of the electric motor, each of the plurality of control units performing the control related to stopping of the electric motor by selecting one of the first signal distributed from the management unit and the second signal input to the second input port.

9. The drive system according to claim 8, wherein
the plurality of control units includes a first control unit connected to the management unit through the second wiring line and arranged adjacent to the management unit, the first control unit further comprising a detection circuit connected to the second input port and configured to detect an abnormality of the second input port, and
the abnormality of the input port is detected by the detection circuit by having the input port of the management unit connected to the detection circuit of the first control unit through the second wiring line.
